(19) United States
(12) Patent Application Publication
(10) Pub. No.: US 2011/0285597 A1
(43) Pub. Date: Nov. 24, 2011

(54) MULTI-BAND ANTENNA ASSEMBLY

(75) Inventors: TAIICHI YAMAGUCHI, Yokohama (JP); JOHN CHOW, Saratoga, CA (US); YUN-CHENG HOU, New Taipei (TW); CHANG-CHING LIN, New Taipei (TW)

(73) Assignee: HON HAI PRECISION INDUSTRY CO., LTD., New Taipei (TW)

(21) Appl. No.: 13/110,045

(22) Filed: May 18, 2011

(30) Foreign Application Priority Data
May 18, 2010 (TW) 99209280

(51) Int. Cl. H01Q 9/04

(52) U.S. Cl. 343/791

(57) ABSTRACT

An antenna assembly (100) includes an antenna (10) and a coaxial cable (20). The antenna includes a first antenna element (11) and a second antenna element (12) bent from a strip-like metal sheet and discrete from the first antenna element. The first and second antenna elements are symmetrically formed with respect to a first axis (X). The coaxial cable is disposed along or parallel with the first axis and includes an inner conductor (21) electrically connected with the first antenna element, and an outer conductor (22) electrically connected with the second antenna element.

### BACKGROUND OF THE INVENTION

1. Field of the Invention

The present invention relates to an antenna assembly, and more particularly to a multi-band discone-type antenna applied in WiMAX (World Interoperability for Microwave Access) or WiFi (Wireless Fidelity).

2. Description of Related Art

Wireless communication devices, such as cellular phones, notebook computers, electronic appliances, and the like, are normally equipped with an antenna that serves as a medium for transmission and reception of electromagnetic signals, such as data, audio, image, and so on. More and more portable electrical devices tend to miniaturization. Accordingly, antenna used in the portable electrical device need to be designed into a more simple configuration.

U.S. Pat. No. 7,286,095 issued to Parsche on Oct. 23, 2007 discloses an inverted feed discone or disc-cone antenna assembly includes an antenna and a coaxial cable connected with the antenna. The antenna includes a conical antenna portion and a flat antenna portion. The coaxial cable comprises an inner conductor connected with the conical antenna portion and an outer conductor connected with the flat antenna portion. Other variations of basic discone antenna continue to evolve.

As one exemplary variation, U.S. Pat. No. 3,987,456 issued to Gelin on Oct. 19, 1976 discloses a wide relative frequency band and reduced size-to-wavelength ratio antenna comprising essentially a first part in the form of a conductor ring and a second part in the form of a skirt respectively connected to the central and outer conductors of a coaxial feeder. The first part has a conductive path in the form of a circumference. The central conductor of the feeder is connected to the mid-point of the said diameter. The second part has a conductive path formed by a circular ring connected to one of the ends of each conducting strand. The conducting strand has the form of broken lines inscribed in isosceles trapezoid. An annular and conical end member is connected to the feeder outer conductor and is in contact with the other ends of the strands.

As another example, U.S. Pat. No. 6,697,031 issued to Jocher on Feb. 24, 2004 discloses a disc-cone antenna comprising a conical member having a fifty ohm air line located within the cone. The conical member is made from conductive material and defines a tubular passageway extending through the cone from a base to an apex. The tubular passageway has a rod of conductive material located therein. One end of the air line is connected to a coaxial connector and the other end or feed is connected to a disc positioned adjacent to the apex of the cone. The body of the co-axial connector is connected to the cone by screws, and the rod within the tubular passageway is connected to the center conductor of the coaxial connector.

The conical or skirt-shaped antenna portion has a complicated configuration and is hard to manufacture.

A multi-band antenna assembly having simple configuration is desired.

### SUMMARY OF THE INVENTION

Accordingly, an object of the present invention is to provide a multi-band antenna assembly having a simple configuration.

In order to achieve the object set forth, an antenna assembly includes an antenna and a coaxial cable. The antenna includes a first antenna element and a second antenna element bent from a strip-like metal sheet and discrete from the first antenna element. The first and second antenna elements are symmetrically formed with respect to a first axis. The coaxial cable is disposed along or parallel with the first axis and includes an inner conductor electrically connected with the first antenna element, and an outer conductor electrically connected with the second antenna element.

The second antenna element is bent from a strip-like metal sheet. Such a second antenna element has a simple configuration and is easy to be manufactured.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a multi-frequency antenna assembly of the present invention within a shielding object;

FIG. 2 is a perspective view showing the antenna assembly according to a first embodiment, omitting the shielding object in FIG. 1;

FIG. 3 is a perspective view showing the antenna assembly according to a second embodiment, omitting the shielding object in FIG. 1;

FIG. 4 is a perspective view showing the antenna assembly according to a third embodiment, omitting the shielding object in FIG. 1;

FIG. 5 is a top view showing the antenna assembly according to a fourth embodiment, omitting the shielding object in FIG. 1;

FIG. 6 is a top view showing the antenna assembly according to a fifth embodiment, omitting the shielding object in FIG. 1;

FIG. 7 is a graph showing the change of the peak realized gain for the first embodiment antenna design with increasing frequency;

FIG. 8 is a graph showing the change of VSWR (Voltage Standing Wave Ratio) for the first, the fourth and the fifth embodiments with the frequency; and

FIG. 9 is a graph showing the change of VSWR for the first, the second and the third embodiments with change frequency.

### DETAILED DESCRIPTION OF THE PREFERRED EMBODIMENT

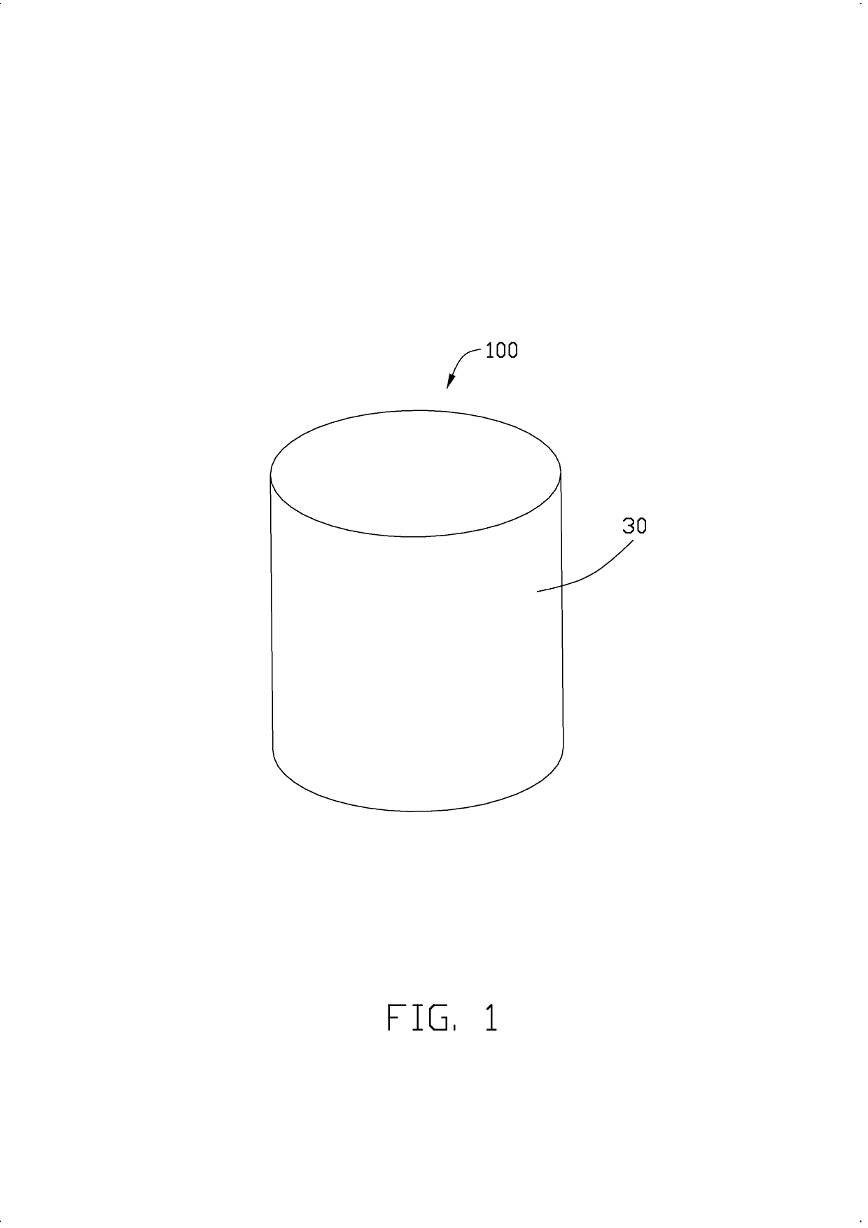

Reference will now be made in detail to the preferred embodiment of the present invention. Referring to FIGS. 1-6, the multi-band antenna assembly 100 is supported by mechanical parts (not shown) and includes an antenna 10, and a coaxial cable 20 connected with the antenna 10. The antenna 10 is suitably used with a curved non-grounded shielding object 30, in order to increase Transmit/Receive (T/R) efficiency characteristic of the discone type antenna, thereby resulting in an improved signal to noise (S/N) ratio, in a way known in this art.

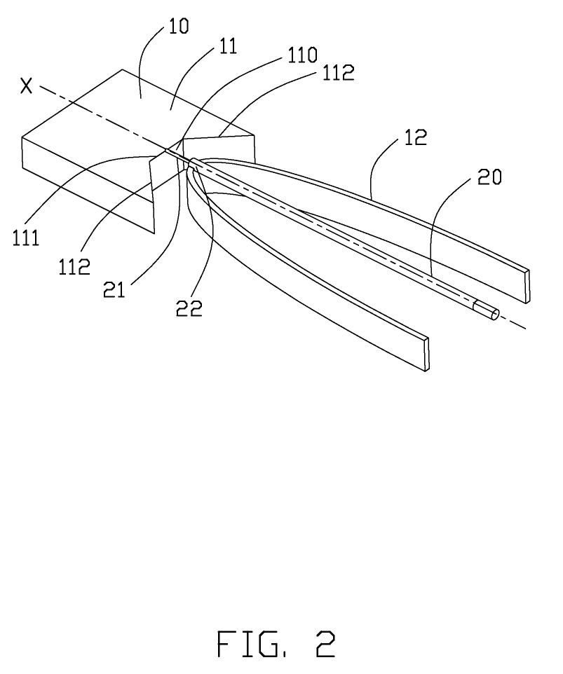

Referring to FIG. 2, the antenna 10 includes a first antenna element or portion 11 and a second antenna element or portion 12 discrete from the first antenna element 11. The first and second antenna elements 11, 12 are symmetrically formed with respect to axis X. The second antenna element 12 lies in an imaginary plane coplanar or parallel with another imaginary plane in which the first antenna element 11 lies.

The coaxial cable 20 is disposed along or parallel with the axis X and includes an inner conductor 21 electrically connected with the first antenna element 11, and an outer conductor 22 electrically connected with the second antenna element 12.

Referring again to FIG. 2, in the first embodiment, the first antenna element 11 is made from a metal block. The first antenna element 11 has a base face 110 facing toward the second antenna element 12. The base face 110 comprises a first face 111 orthogonal to the axis X and a pair of second faces 112 extending obliquely toward the second antenna element 12 from opposite sides of the first face 111.

The second antenna element 12 is bent from a strip-like metal sheet and is shaped into a parabola extending along a direction leaving away from the first antenna element 11. The thickness of the base face 110, i.e., the thickness of the first antenna element 11 is identical to that of the second antenna element 12.

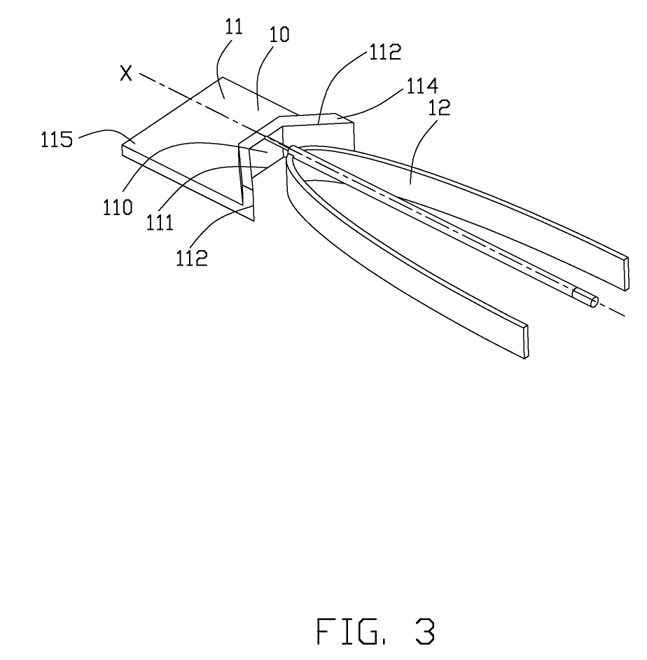

Referring to FIG. 3, in the second embodiment, the first antenna element 11 is bent from a metal plate. The first antenna element 11 includes a body portion 115 and a base portion 114 bent vertically from the body portion 115. The base portion 114 has a base face 110 facing toward the second antenna element 12. The base face 110 comprises a first face 111 orthogonal to the axis X and a pair of second faces 112 extending obliquely toward the second antenna element 12 from opposite sides of the first face 111. The thickness of the body portion 115 is smaller than that of the second antenna element 12. The second antenna element 12 has a configuration same to that referred in the first embodiment.

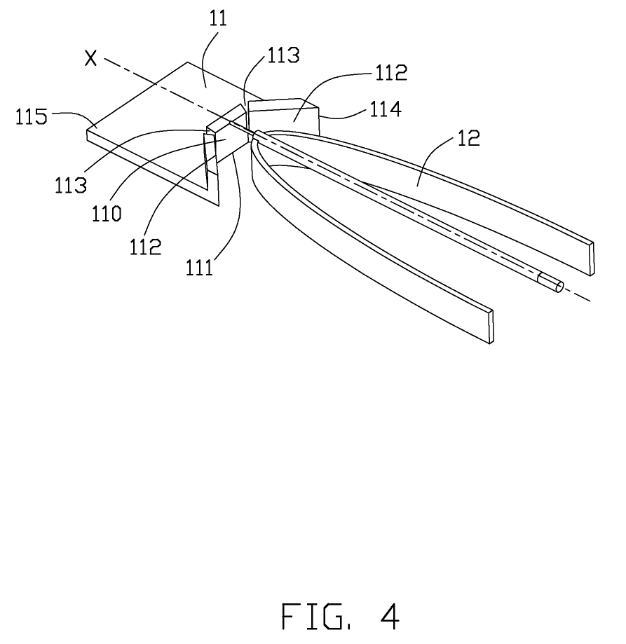

Referring to FIG. 4, in the third embodiment, the first antenna element 11 is bent from a metal plate. The first antenna element 11 includes a body portion 115 having three edges and three base portions 114 bent vertically from the three edges of the body portion 115. The three base portions 114 respectively have three faces, i.e., a first face 111 orthogonal to the axis X and a pair of second faces 112 extending obliquely toward the second antenna element 12. The first face 111 and the pair of second faces 112 constitute a base face 110 facing toward the second antenna element 12. The first and second faces 111, 112 has two slits 113 defined therebetween. Optionally, the base face 110 could be consisted of the first face 111 and more number of the second faces 112, with corresponding number of slits 113 defined therein. The second antenna element 12 otherwise has a configuration same to that referred in the first embodiment.

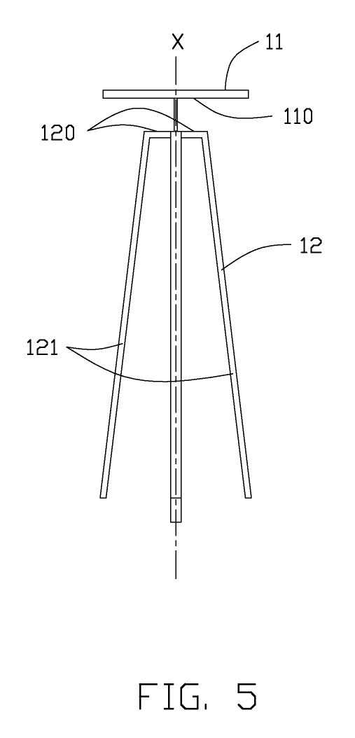

Referring to FIG. 5, in the fourth embodiment, the first antenna element 11 has a base face 110 orthogonal to the axis X and facing toward the second antenna element 12.

The second antenna element 12 of the fourth embodiment has a head portion 120 orthogonal to the axis X and a pair of shoulder portions 121 extending obliquely from opposite sides of the head portion 120 toward a direction leaving away from the first antenna element 11. The second antenna element 12 in the fourth embodiment could be applied in the first through third embodiments.

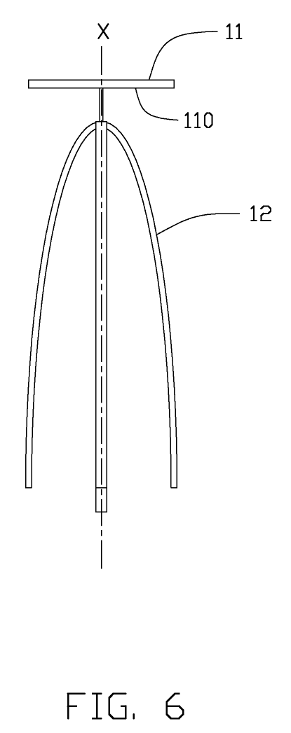

Referring to FIG. 6, in the fifth embodiment, the first antenna element 11 has a base face 110 orthogonal to the axis X and facing toward the second antenna element 12. The second antenna element 12 has a configuration same to that referred in the first embodiment.

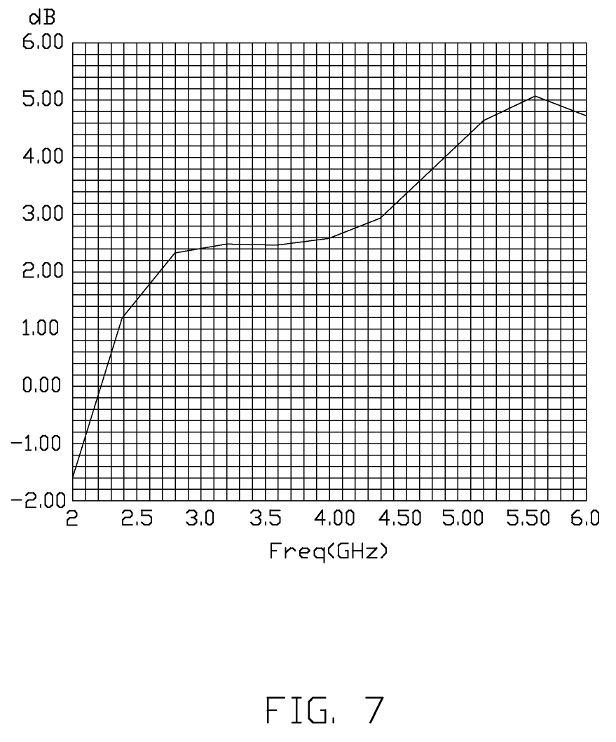

FIG. 7 is a graph showing the change of the peak realized gain for the first embodiment antenna design with increasing frequency. The peak realized gain would be increased when the frequency is increased.

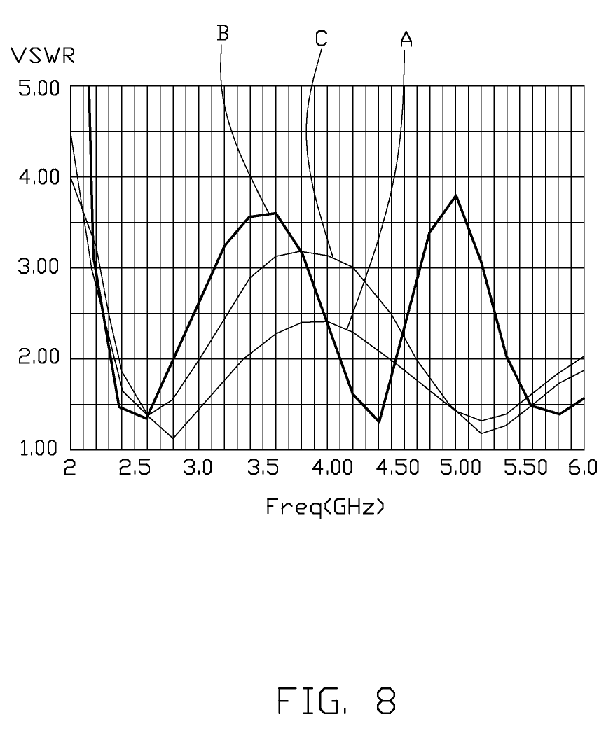

FIG. 8 is a graph showing the change of VSWR for the first, the fourth and the fifth embodiments with the frequency. Line A indicates the change of VSWR in the first embodiment. Line B indicates the change of VSWR in the fourth embodiment. Line C indicates the change of VSWR in the fifth embodiment. In the first, the fourth and the fifth embodiments, VSWR is less than 4.0, when frequency is between 2.3 GHz and 6 GHz. In the fifth embodiment, VSWR is less than 3.5, when frequency is between 2.3 GHz and 6 GHz. In the first embodiment, VSWR is less than 2.5, when frequency is between 2.3 GHz and 6 GHz.

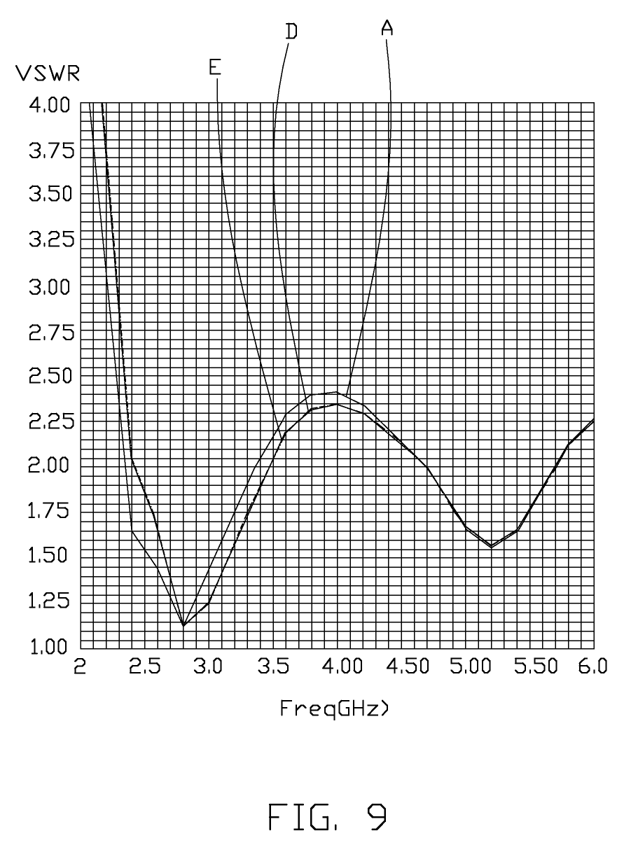

FIG. 9 is a graph showing the change of VSWR for the first, the second and the third embodiments with change frequency. Line A indicates the change of VSWR in the first embodiment. Line D indicates the change of VSWR in the second embodiment. Line E indicates the change of VSWR in the third embodiment. In the first, the second and the third embodiments, VSWR is less than 2.5, when frequency is between 2.3 GHz and 6 GHz. Line D and line E almost overlap with each other, when frequency is between 2.3 GHz and 6 GHz.

The antenna assembly 100 has a simple configuration and is easy to be manufactured.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna assembly comprising:
an antenna including a first antenna element and a second antenna element bent from a strip-like metal sheet and discrete from the first antenna element, said first and second antenna elements being symmetrically formed with respect to a first axis; and
a coaxial cable disposed along or parallel with the first axis and including an inner conductor electrically connected with the first antenna element, and an outer conductor electrically connected with the second antenna element.

2. The antenna assembly as claimed in claim 1, wherein said second antenna element is shaped into a parabola extending along a direction leaving away from the first antenna element.

3. The antenna assembly as claimed in claim 2, wherein said first antenna element has a base face facing toward the second antenna element.

4. The antenna assembly as claimed in claim 3, wherein said first antenna element is made from a metal block, said base face of the first antenna element comprising a first face orthogonal to the first axis and a pair of second faces extending obliquely toward the second antenna element from opposite sides of the first face.

5. The antenna assembly as claimed in claim 3, wherein said first antenna element is bent from a metal plate and comprises a body portion and a base portion bent vertically from the body portion, said base face being formed on said base portion and comprising a first face orthogonal to the first axis and a pair of second faces extending obliquely toward the second antenna element from opposite sides of the first face.

6. The antenna assembly as claimed in claim 3, wherein said first antenna element is bent from a metal plate and includes a body portion having three edges and three base portions bent vertically from the three edges of the body portion, said three base portions respectively having a first face orthogonal to the first axis, and two second faces extending obliquely toward the second antenna element, said first face and the two second faces constituting said base face, with two slits defined between adjacent first and second faces.

7. The antenna assembly as claimed in claim 3, wherein said base face is orthogonal to the first axis.

8. The antenna assembly as claimed in claim 1, wherein said second antenna element comprises a head portion orthogonal to the first axis and a pair of shoulder portions extending obliquely from opposite sides of the head portion toward a direction leaving away from the first antenna element, and said first antenna element has a base face orthogonal to the first axis and facing toward the second antenna element.

9. The antenna assembly as claimed in claim 1, wherein said second antenna element lies in an imaginary plane coplanar or parallel with another imaginary plane in which said first antenna element lies.

10. An antenna assembly comprising:
a first antenna defining a center line in a longitudinal direction and a first height at a boundary area in a height direction perpendicular to said longitudinal direction;
a second antenna spaced from the boundary area, formed by a sheet metal, and bent in a symmetrical manner with regard to the center line, said second antenna defining a second height in said height direction similar to said first height; and
a coaxial cable extending along the center line and defining an outer conductor linked to the second antenna, and an inner conductor linked to the first antenna.

11. The antenna assembly as claimed in claim 10, wherein the second antenna is curved around the center line.

12. The antenna assembly as claimed in claim 10, wherein the first antenna defines a plurality of angled sections facing the second antenna.

13. The antenna assembly as claimed in claim 10, wherein the boundary area complies with a configuration of an adjacent area of the second antenna.
